(19) United States
(12) Patent Application Publication
(10) Pub. No.: US 2023/0381988 A1
(43) Pub. Date: Nov. 30, 2023

(54) HELMET FOR CUTTING HAIR BY ARTIFICIAL INTELLIGENCE AND METHOD THEREOF

(71) Applicant: Basil Yehea Alkahtani, Riyadh (SA)

(72) Inventor: Basil Yehea Alkahtani, Riyadh (SA)

(21) Appl. No.: 18/331,088

(22) Filed: Jun. 7, 2023

Related U.S. Application Data
(63) Continuation-in-part of application No. PCT/SA2021/050026, filed on Dec. 22, 2021.

(30) Foreign Application Priority Data
Dec. 9, 2020 (SA) 120420282

(51) Int. Cl. A45D 44/02; B26D 5/00

(52) U.S. Cl. CPC A45D 44/02; B26D 5/00

(57) ABSTRACT

A device having a helmet formed by a top part (1), for cutting hair, that is placed on the head and completely covers the area of the hair of the head down to the neck and which is connected, by means of a fastening tool (16), to a bottom part (2) for cutting beards and moustaches. The helmet contains at least one sensor (21) for reading and analyzing the length, type and position of the hair, which is connected to at least one moveable blade (3) that can be moved along at least one specific path (6) defined according to the direction required for cutting the head hair, and at least one blade (17) that moves within at least one path (18) for cutting the beard.

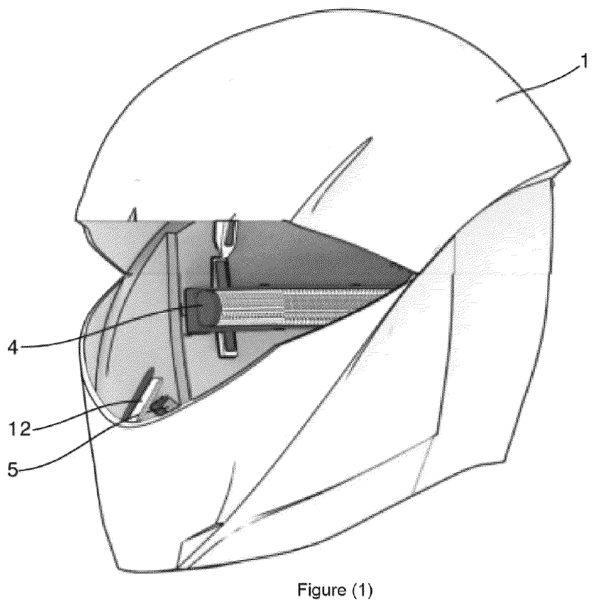

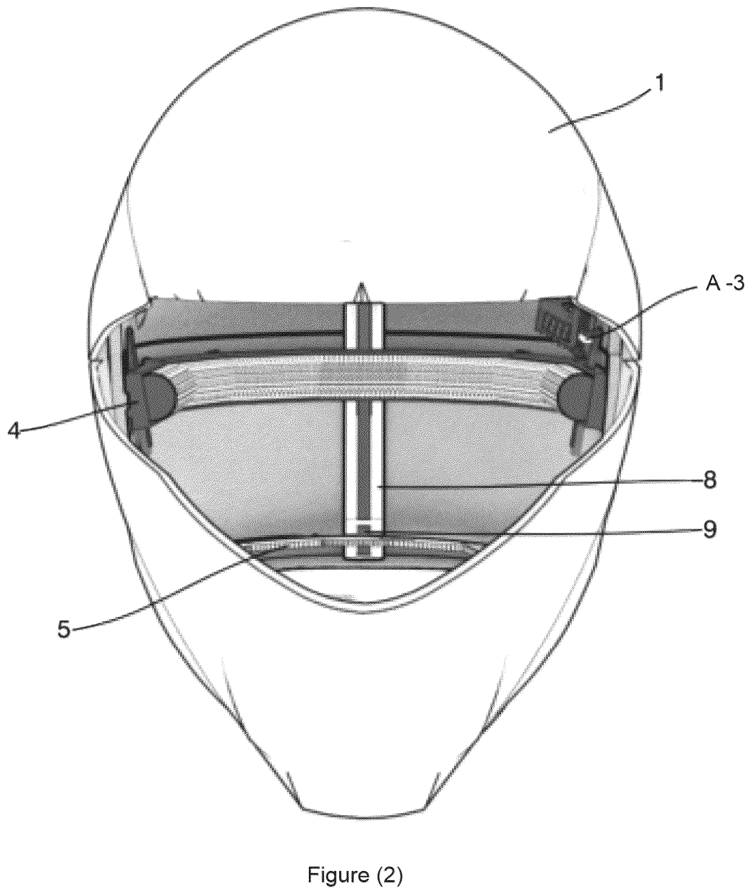

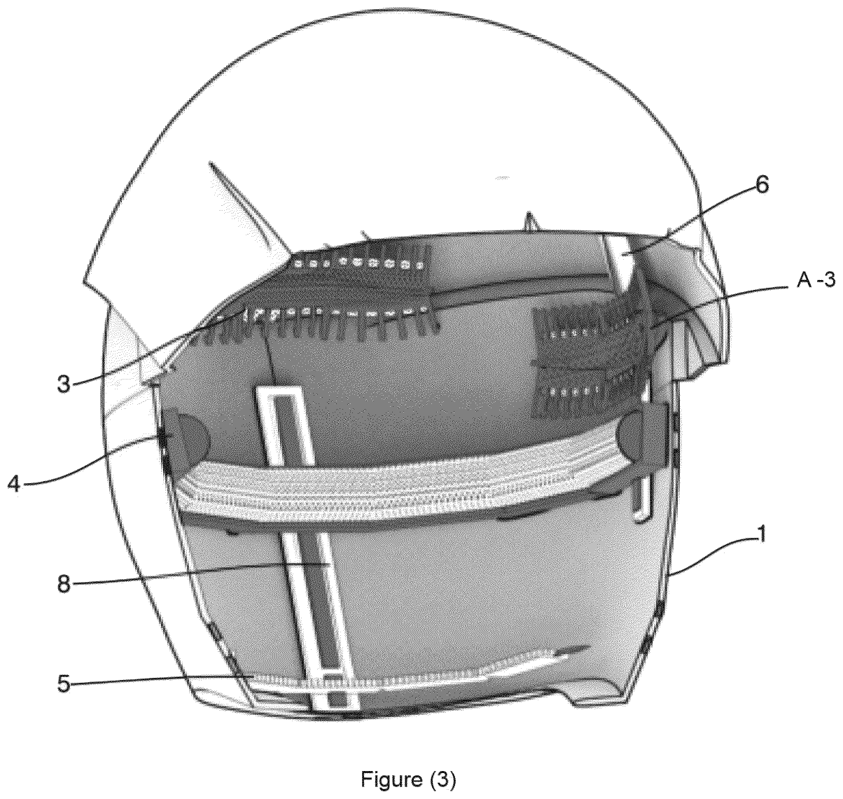

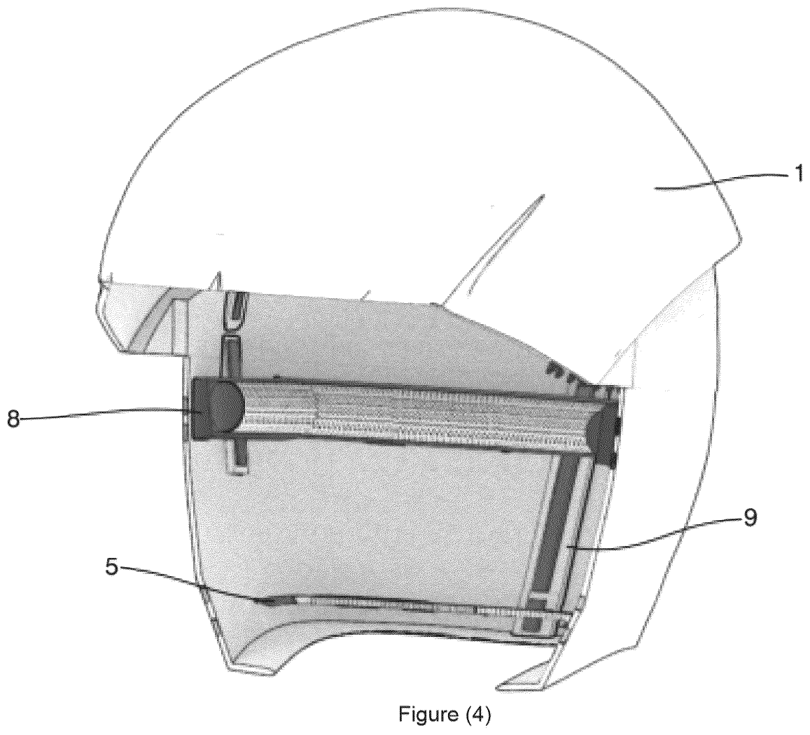

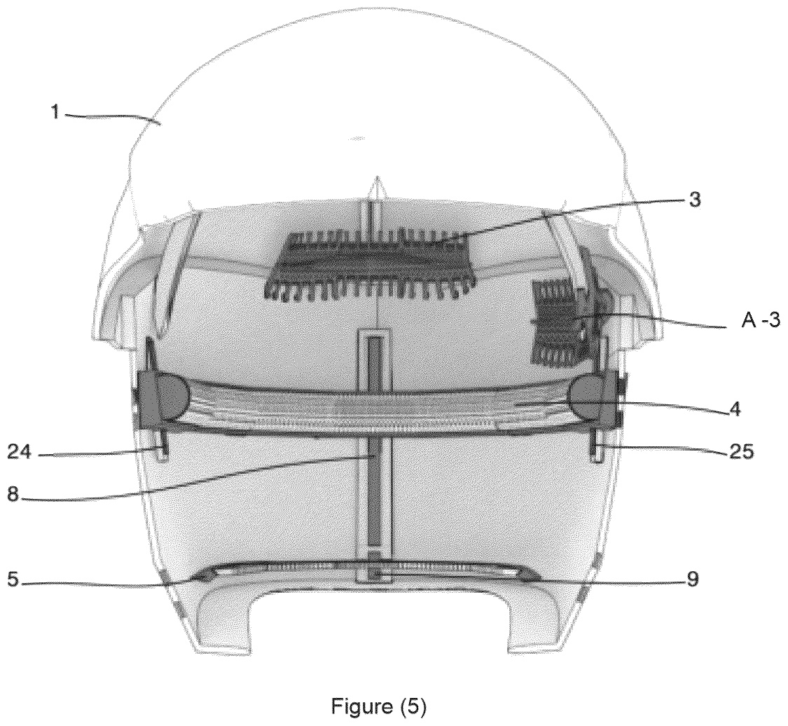

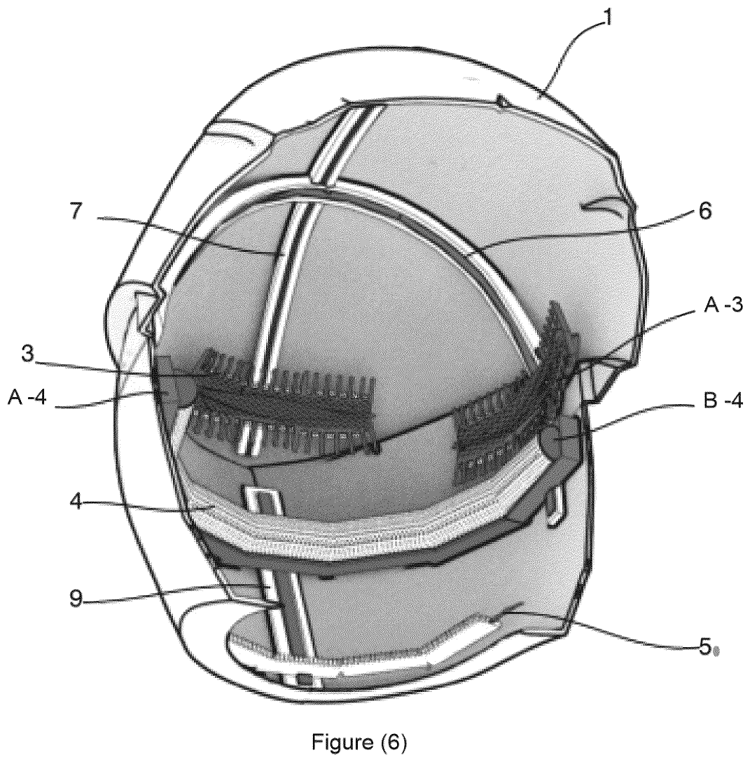

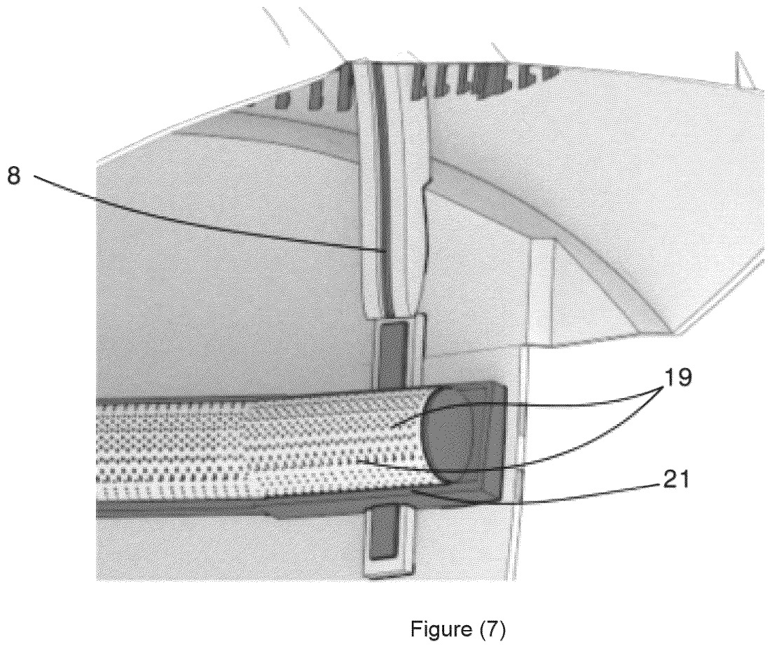

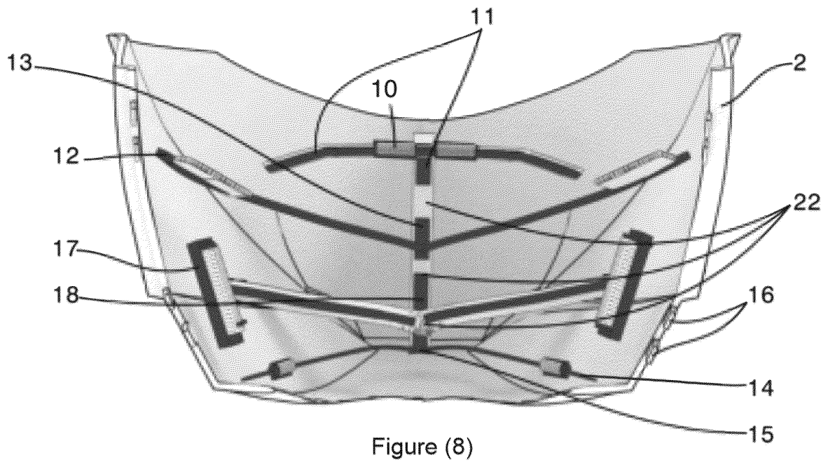

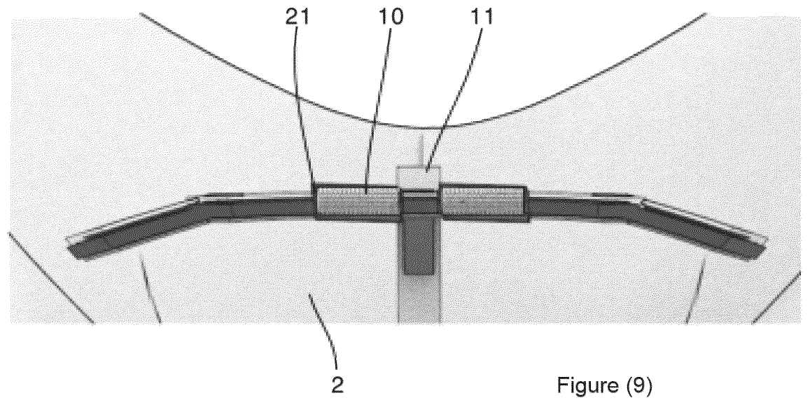

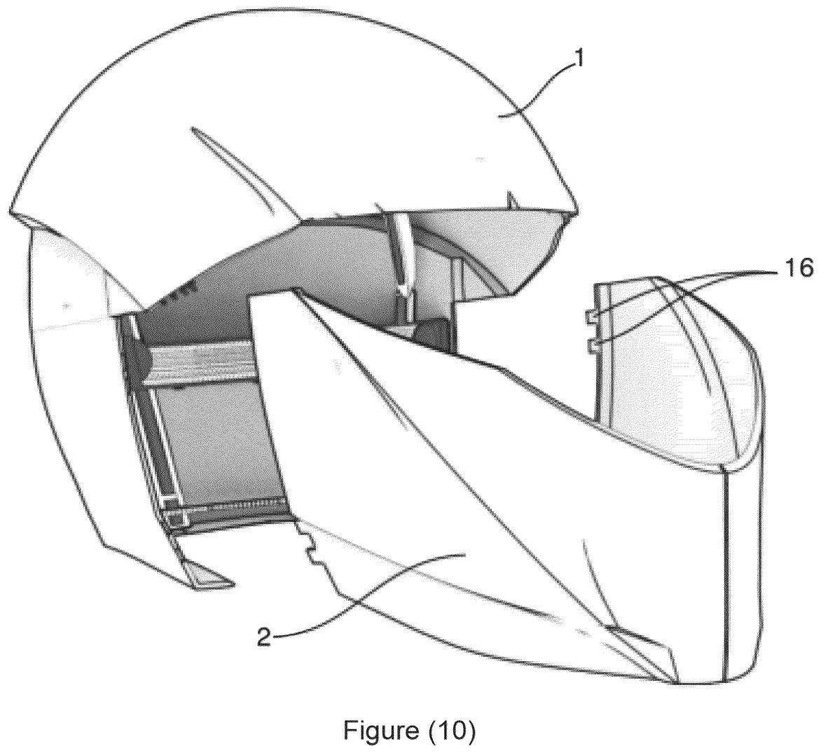

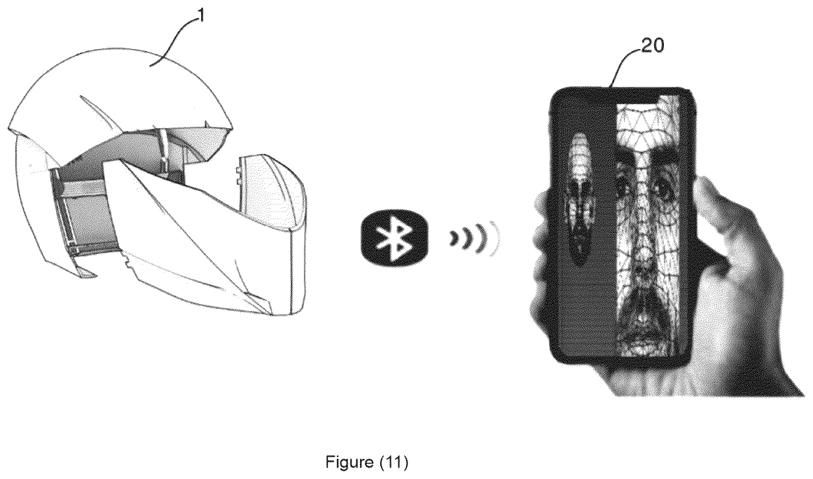

### CROSS-REFERENCE TO RELATED APPLICATION

This application is a continuation-in-part of International Patent Application No. PCT/SA2021/050026 filed on Dec. 22, 2021, entitled INTELLIGENT HELMET FOR HAIR CUTTING AND BEARD TRIMMING, which claims priority benefit of Saudi Arabian Patent Application No. 120420282 filed on Dec. 9, 2020, entitled HELMET FOR CUTTING HAIR BY ARTIFICIAL INTELLEIGENCE AND METHOD THEREOF, which is incorporated herein by reference in its entirety.

### FIELD OF THE INVENTION

The present invention relates to a helmet-shaped device that covers the head and chin area using artificial intelligence, blades, sensors, and auxiliary software to cut head hair and facial hair.

### BACKGROUND OF THE INVENTION

The present invention relates to hair cutting and shaving tools and devices, particularly to an autonomous/automatic hair cutting and shaving system using a helmet that covers the hair area on the head and chin, employing artificial intelligence (AI) to automatically understand user preferences without human intervention, and providing remote control capabilities.

In current technologies, it is known to use separate hair or beard trimmers manually, as in European Patent No. 3331670 dated Feb. 26, 2020, titled HAIR CONTAINER AND KIT FOR A HAIR CUTTING APPLIANCE. Drawbacks of these applications include the possibility of changing barbers or locations, inconvenient appointment times, and the need to repeatedly inform the barber of haircut preferences each visit.

Robot-assisted shaving has been around for some time, as demonstrated in U.S. Pat. No. 4,602,542 dated Jul. 29, 1986, titled AUTOMATIC HAIR CUTTING APPARATUS. The device uses a robotic arm to locate the head and hair, measure hair length, and other specifications. However, it is impractical due to its large size, cost, and difficulty in acquisition and use for the general public, as well as its limited portability.

Devices designed to adjust the appropriate position on the head to aid in hair cutting are common in some inventions, such as U.S. Pat. No. 10,307,921 dated Jul. 4, 2019, titled AUTOMATED HAIR CUTTING SYSTEM AND METHOD OF OPERATION THEREOF. However, these devices are still impractical, unlikely to be accepted by customers, and prone to varying readings depending on the position of device number (112). Additionally, the use of the hair cutting machine (200) still requires manual operation, either by the user or another person.

The shortcomings of these previous technologies include a lack of precision, high cost, difficulty in use, limited portability, significant time spent on hair cutting and waiting, or traveling to the barbershop, as well as repeated explanations to the barber during each haircut. Furthermore, they are marred by wasted time when replacing blades or changing sizes based on customer requests, especially for those who frequently visit the barbershop for hair or beard trimming.

### SUMMARY

A device having a helmet formed by a top part (1), for cutting hair, that is placed on the head and completely covers the area of the hair of the head down to the neck and which is connected, by means of a fastening tool (16), to a bottom part (2) for cutting beards and moustaches. Inside the helmet, there is at least one sensor (21) for reading and analyzing the length, type, and position of the hair, connected to at least one movable blade (3) on at least one dedicated and specific track (6) according to the desired direction for head shaving. Similarly, there is at least one blade (17) that moves within at least one dedicated track (18) for shaving the chin. This is done entirely using artificial intelligence through a pre-programmed application that wireles sly gives commands to the blades to move as needed. The general aim of the invention is to cut hair and beard in a very short time without human intervention and with high quality, efficiency, and precision using advanced technologies. The invention can identify, analyze, and study haircut choices based on the input information collected during the use of the invention.

These, and other objects, features and advantages of this invention will become apparent from the following detailed description of the various aspects of the invention taken in conjunction with the accompanying drawings.

### BRIEF DESCRIPTION OF THE DRAWINGS

The present invention will be understood more fully from the detailed description given hereinafter and from the accompanying drawings of certain embodiment of the present invention, which, however, should not be taken to limit the invention, but are for explanation and understanding only.

FIG. (1) illustrates a side cross-section of the complete helmet;

FIG. (2) shows a front view of the helmet;

FIG. (3) shows the inside of the helmet, including shaving blades for the head in the upper area, middle area, and neck hair;

FIG. (4) is a front cross-section showing all the blades for the head hair area;

FIG. (5) is a front cross-section showing all the blades for the head hair area;

FIG. (6) is an internal cross-section illustrating the blades and their tracks in the upper head area;

FIG. (7) shows one of the blades and the openings for hair collection in the head area and its corresponding track;

FIG. (8) displays the lower part of the helmet, designed for shaving mustache and chin hair, with its blades and corresponding tracks;

FIG. (9) shows the blades for shaving or trimming the mustache area and its corresponding track;

FIG. (10) illustrates the appearance of the helmet when the upper and lower parts are separated; and

FIG. (11) demonstrates one embodiment of the method for connecting the helmet to the user devices to provide commands.

### DETAILED DESCRIPTION OF THE INVENTION

The primary goal of this invention, considering the above, is to solve the aforementioned technical problems and to facilitate ease of use by employing modern technologies such as artificial intelligence (AI), machine learning, and the Internet of Things (IoT) in an accessible and affordable manner, suitable for all segments of society. This invention aims to be cost-effective, aesthetically pleasing, and well-designed to enhance the quality and efficiency of hair cutting and shaving according to the user's preferences and at the most convenient time, without the need to explain how to cut or shave each time. This helmet is characterized by its versatility as an invention with multiple applications, serving as a single device for cutting head hair, chin hair, and mustache simultaneously to reduce shaving time, or for separate use of each feature. The upper part (1) is for cutting head hair, while the lower part (2) is for cutting chin hair and mustache.

During manufacturing, factors such as user age, hair type, body size, countries of use, and materials used in production are also considered.

Further aspects and advantages of the invention will become apparent from the following description and accompanying claims.

This invention is considered an integrated device as shown in FIG. (1). The user can use it as two separate parts, which can be detached as needed or for maintenance purposes as shown in FIG. (10). Using the helmet fully is important for adjusting the shaving position, so it is considered as a single device regardless of the part used.

FIG. (10) shows that the helmet can be separated into an upper part (1) and a lower part (2) connected to each other through a fixing tool (16) with the other part of the helmet to ensure the helmet's stability, suitability for the head and chin shape, and to ensure the effectiveness of the suction openings and the internal shaving blades.

Inside the upper part of the helmet, there are several openings for hair suction and internal blades for shaving or cutting head hair, consisting of 3 levels. FIG. (6) shows the first level, which is specific to the upper part of the hair. Suction openings, and within them the first blade (3), are for cutting hair from front to back and vice versa through its dedicated track (7). Suction openings and the other blade (3-A) are for cutting and suctioning hair from right to left and vice versa through its dedicated track (6). The suction openings and blade move forward and backward then return to the front to ensure that the head hair has been shaved or cut completely from all sides.

The second level has two tracks dedicated to cutting or shaving hair from the sides above the ear area and the back area of the head hair. The suction openings and the internal blades (4) move on the track (8) from top to bottom and vice versa, as shown in FIG. (5).

The suction openings and the internal blades (4-A and 4-B), shown in FIG. (6), are for shaving hair above and around the ear area, moving through their dedicated tracks (24 and as illustrated in FIG. (5).

The third level is dedicated to shaving the lower part of the hair at the back of the head (neck hair), where the blade (5) moves horizontally as well as up and down and vice versa within its dedicated track (9) as shown in FIG. (5).

FIG. (8) shows the lower part (2) of the helmet for trimming and shaving the mustache and chin, which consists of several suction openings with internal blades and tracks that correspond to the coordinates and contours of the face and jaw. Suction openings and the blade (10) are for cutting and suctioning hair in the mustache area within its dedicated track (11). As for the suction openings and internal blades for the chin, they consist of three levels; the first level: the blade for the upper part of the chin (temporal area) (12) moves within its dedicated track either inward and outward or up and down through the track (13) to define the chin edges. The second level: suction openings and internal blades for the chin (17) move inward and outward, up and down through the track (18). The third level: suction openings and internal blades (14) for cutting hair in the lower chin area move inward and outward, as well as up and down through the track (15), as shown in FIG. (8).

These blades can move in different directions and at varying speeds simultaneously, either automatically according to the programming and self-settings on the user's device or manually by entering the required data and information. The presence of sensors inside the helmet helps analyze the current hair situation and work harmoniously and effectively. One of the features of the suction openings and internal blades is their ability to cut hair in various sizes, whether in millimeters or centimeters, ensuring a better shave or cut than a barber does. Another feature is that, when the hair enters through the openings, it can cut or shave according to the commands entered through the application or program used.

As shown in FIG. (7), the shaving blades (4) consist of small openings (17) of different sizes (approximately 0-4 mm) through which the hair enters and is cut by sharp internal blades that move back and forth quickly, ensuring that all hair is cut evenly in the specified size without causing any damage to the skin, whether on the head, chin, or mustache. The diameter of these openings can be increased according to their purpose.

The shaving blades are operated, managed, and controlled entirely and automatically using Artificial Intelligence, Machine Learning, and the Internet of Things. The software or application used can be installed on various electronic devices (mobile phones, tablets, computers, or others) that can be used to recognize the face, identify the shaving areas, determine hair type and length, and copy the information after capturing it in three dimensions or any technology used to determine the coordinates for the head or chin shape using sensors distributed within the helmet or by capturing images from the electronic device to cover the entire head and chin area. This software or application can be used in the absence of an internet connection, and it can also maintain a permanent internet connection to update information, collect as much data as possible, read and analyze the user's hair, suggest a suitable style, or allow the user to specify a particular shave by drawing it through the software or application.

The Internet of Things technology can be illustrated by having a communication network and connection between the helmet and the mobile device, as well as between the helmet and another helmet and another mobile device, with a communication and connection network between them, allowing the transmission of information, parameters, settings, and shaving data from one helmet to another mobile device, from one helmet to another, or from one mobile device to another. This information consists of data parameters for the haircut method, and since the Machine Learning technology relies on the helmet learning the user's hair cutting method for head hair and the shaving or trimming method for facial hair every time they use it, the helmet understands the user's preferences for both head hair cutting and facial hair care. It always maintains the same style according to the machine learning acquired through the user's hair cutting and facial hair styles, both before and after using the helmet. This is because when the user gets a haircut from another barber, the helmet scans the user's head and hair using its internal sensors and then performs the cut or shave until the user is satisfied with the process.

In this invention, data is collected and analyzed after the first actual initial use and with repeated use, and this information is linked to the date, time, time zone, location, skin color, age, and weight of the user. This data is used to generally analyze the user's personality and provide appropriate suggestions, and the machine teaches itself using this data and information and employing Machine Learning technology. This helmet can be used and commanded through the application even if the actual user is not near the helmet, as it can be used by one person for another through the Internet of Things. The user can also draw a specific or custom haircut, determine the cutting locations and required degree, and how to cut, as well as learn how to shave through its use.

Through repeated use, a unique database is built for the primary user, specifying a name or address for the haircut's name, and automatically presenting suggestions and recommendations, including reminders for shaving time and alerts for new and suitable haircuts for the user. This software or application also enables the identification of multiple users and various haircuts. It can also connect to more than one helmet at the same time and determine similar or different haircuts according to the program settings.

The helmet is powered by batteries, which are charged through electricity. These batteries can be recharged multiple times (lithium) and can be replaced with a replaceable battery (alkaline) as needed. The batteries are connected to a control system board and several electric motors that convert electricity into mechanical work and can be charged via a fast-charging cable.

Additional features of the helmet include easy-to-remove and install suction openings and blades. It is also equipped with 21 specialized sensors for areas requiring high precision in identification, and it is safe for the user by sensing the presence of any excess skin or wounds on the body. In case of any obstacles, it can bypass them or stop working. This can be adjusted according to user preference, allowing for semi-automatic or manual shaving or cutting.

Another feature is that the helmet does not operate if the position of the helmet on the head or chin is not set correctly, as previously specified or in the correct manner, based on instructions from the software or application that primarily relies on the original user's artificial intelligence. This feature can be modified if the user is not the primary user.

In one particular embodiment an AI-powered haircut helmet has an upper part (1) and a lower part (2) connected to each other by a fastening tool (16) to ensure proper functioning of the cutting blades and accurate data and information collection. The inner part of the upper part (1) of the helmet features multiple blades and hair suction openings (3, 3-A, 4, 4-A, 4-B, 5) for cutting and shaving head hair, moving in various directions and speeds along their designated tracks (6, 7, 8, 9). Sensors (21) are connected to the blades for measuring hair length, type, and density, and for determining the appropriate haircut or shave with high accuracy. The lower part (2) of the helmet features multiple blades and suction openings (10, 12, 14, 17) for cutting and shaving facial hair, moving in various directions and speeds determined by the AI along their designated tracks (11, 13, 15, 18). The hair cutting method is safe, as hair is suctioned into the openings and cut by the internal blades without directly exposing the user's skin to the cutting process, preventing injury or scratches.

The helmet may have the suction openings used to suction hair, and the internal blades within the openings are used to cut the hair.

The helmet may have precise control and determination of the desired haircut or shave for the desired part of the hair, with very high accuracy in cutting hair length, up to 0.1 millimeters, according to the user's desired measurements and settings, by moving the blades inside the suction openings.

The helmet may have the cutting, shaving, or trimming process and the desired size and degree are based on readings and analysis of the coordinates obtained from the sensors (21) connected to the blades and/or imaging sensors and/or manual data input and commands from the user. The program or application may automatically send wireless commands to the blades through the mobile device (20) to perform the required tasks.

The helmet may have the blades feature openings (19) of different sizes.

The helmet may be powered by rechargeable lithium based batteries, which can be charged with electricity and replaced with changeable alkaline based batteries if needed. The batteries are connected to a control panel and several electric motors that convert electricity into mechanical work. The batteries can be charged using a fast-charging cable.

The helmet may have a computer-readable medium to assist the AI in its task of inputting hair cutting commands in the manner desired by the user through the Internet of Things (IoT) and machine learning. There may be a communication and connection network between the helmet, the mobile device, other haircut helmets, and other mobile devices, enabling the exchange of haircut information, equations, and data from one helmet to another or from one mobile device to another. The information consists of data equations for hair cutting methods in relation to IoT, with the helmet learning the user's haircut preferences each time they cut their hair, in order to understand the user's haircut style and consistently achieve the same results based on the machine learning acquired through the user's haircut style. This process occurs before using the helmet, during its use, and when the user gets a haircut from another barber. The helmet creates a digital scan of the user's head and facial hair using its internal sensors, replicates the previous haircut from any barber, saves it, and repeats the same haircut, hair length, hairstyle, and hair shape with the same precision, improving the haircut until the user is satisfied.

### Usage Method

One of the embodiments or examples of how this helmet works for shaving or cutting hair is as follows: As shown in FIG. (20), the user starts the software or application on their mobile device (20) and places the helmet on their head and chin. Then, the imaging sensors begin scanning, or the user takes a picture of themselves with their mobile device, creating a 3D diagram, identifying hair type, length, and boundaries, which then appear on the mobile device screen (20). The software or application then searches for the entered data and, based on the gathered information from the user, selects the appropriate haircut (this can be repeated until the right haircut is chosen). The suction openings and shaving blades (3, 3-A, 4, 5) in the scalp area start moving in all directions, preparing for cutting or shaving through their designated tracks (6, 7, 8, 9). The suction openings and internal blades start gathering hair through the openings (19), where sensors (21) on the blade determine the length and density of the hair strands in each opening on the scalp and the required length and shaving position as shown in FIG. (7). The desired area to be shaved can be selected by specifying a particular blade.

In another embodiment for trimming or shaving the mustache, the imaging sensors take dimensions of the nose, lips, and distances between them and the chin for precise and accurate shaving without causing any harm. The hair is gathered through the blade openings (17), measuring lengths, identifying hair type and locations on the face, and then cutting the hair according to the suggestions provided by the software or application, or manually, depending on the user's choice. These dimensions are repeatedly measured by the sensors connected to the internal blades to ensure a consistent and orderly shaving process.

A method for using the helmet may include placing the helmet on the desired hair area to be cut or shaved, and activating the application on the mobile device (20). The imaging sensors in the helmet parts (1 and 2) capture a three-dimensional (3D) representation of the hair area and scale it to the mobile device, as shown in FIG. (11), or the user takes a photo of themselves with the mobile device and creates a 3D schematic drawing. The blades then gather hair through the openings (19), and the sensors (21) adjacent to them determine the hair type and send this information to the application. This data is analyzed, and a suitable haircut is suggested or manually selected by the user.

The user can preview the haircut on the mobile device in the form of a 3D rendering, helping them decide on the haircut and visualize their appearance after the haircut. Afterward, the command is given to automatically move the required blades to execute the cutting or shaving process.

Additional features include manual control of the blades and suction openings for the entire helmet. Specific blades can be operated in the upper and/or lower part, for example, selecting blades for the mustache and the back of the head only.

When manufacturing this helmet, the materials used are lightweight, shock-resistant, and easily detachable from the lower part. Blades can be easily replaced and changed without the need for specialists.

Several hair extraction methods can be used to facilitate shaving or cutting hair. For example, a special track can be added inside the blades to extract the cut hair, allowing the blades to work smoothly and naturally without affecting hair measurements and lengths or obstructing the blades due to hair accumulation.

In this manner, the purpose of using this invention is achieved, as it solves previous technical problems through a helmet for cutting hair on the head and chin using modern technologies such as Artificial Intelligence, Machine Learning, and the Internet of Things.

A person skilled in this field will recognize, after benefiting from this disclosure, that other models can be invented that do not depart from the scope of the invention as disclosed in this application. Accordingly, the scope of the invention is limited only by the following claims.

What is claimed is:

1. An artificial intelligence programed haircut helmet, comprising:
an upper part and a lower part connected to each other by a fastening tool to ensure proper functioning of the cutting blades and accurate data and information collection;
the upper part of the helmet has an inner surface and an outer surface with an internal space therebetween, the inner surface having hair suction opening leading to the internal space and the internal space having multiple blades for cutting and shaving head hair entering the suction openings, the multiple blades moving in various directions and speeds along their designated tracks;
sensors are connected to the blades, the sensors measuring hair length, type, and density, and determining the accuracy of the haircut or shave;
the lower part of the helmet has an inner surface and an outer surface with an internal space therebetween, the inner surface having hair suction opening leading to the internal space and the internal space having multiple blades for cutting and shaving facial hair entering the suction openings, the multiple blades moving in various directions and speeds along their designated tracks determined by the artificial intelligence (AI) along their designated tracks;
wherein hair suctioned into the suction openings of the upper part is cut by the internal blades without directly exposing a user's skin to the internal blades; and
wherein hair suctioned into the suction openings of the lower part is cut by the internal blades without directly exposing the user's skin to the internal blades.

2. The helmet of claim 1, wherein the suction openings suction hair, and the multiple blades within the openings cut the hair.

3. The helmet of claim 1, wherein control and determination of the desired haircut or shave for the desired part of the hair is provided, with accuracy in cutting hair length up to 0.1 millimeters, according to the user's desired measurements and settings, by moving the blades inside the suction openings.

4. The helmet of claim 1, further comprising a mobile computing device, the mobile computing device having a program or application configured to send commands to the helmet; and
wherein the helmet and the mobile computing device are in wireless communication.

5. The helmet of claim 1, wherein the cutting, shaving, or trimming process and the desired size and degree are based on readings and analysis of the coordinates obtained from the imaging sensors and commands from the user; and
wherein the program or application automatically sends wireless commands to the blades through a mobile device to perform the required tasks.

6. The helmet of claim 1, wherein the cutting, shaving, or trimming process and the desired size and degree are based on readings and analysis of the coordinates obtained from the sensors connected to the blades and commands from the user; and
wherein the program or application automatically sends wireless commands to the blades through a mobile device to perform the required tasks.

7. The helmet of claim 1, wherein the cutting, shaving, or trimming process and the desired size and degree are based on readings and analysis of the coordinates obtained from manual data input and commands from the user entered by a mobile device; and
wherein the program or application automatically sends wireless commands to the blades through the mobile device to perform the required tasks.

8. The helmet of claim 1, wherein the blades feature openings of different sizes.

9. The helmet of claim 1, further comprising rechargeable lithium based batteries, which can be charged with electricity and replaced with changeable alkaline batteries if needed;
the batteries are connected to a control panel and several electric motors, providing power, to convert electricity into mechanical work. The batteries can be charged using a fast-charging cable.

10. The helmet of claim 1, further comprising changeable alkaline batteries, the batteries are connected to and provide power to a control panel and several electric motors, to convert electricity into mechanical work.

11. The helmet of claim 9, wherein the batteries can be charged using a fast-charging cable.

12. The helmet according to claim 1, further comprising a computer-readable medium to assist the AI in its task of inputting hair cutting commands in the manner desired by the user through the Internet of Things (IoT) and machine learning;
wherein a communication and connection network between the helmet, the mobile device, other haircut helmets, and other mobile devices, enabling the exchange of haircut information, equations, and data from one helmet to another or from one mobile device to another;
the information consists of data equations for hair cutting methods in relation to IoT, with the helmet learning the user's haircut preferences each time the user cuts their hair, in order to understand the user's haircut style and provide a consistent results based on the machine learning acquired through the user's haircut style; wherein this process occurs before using the helmet, during its use, and when the user gets a haircut from another barber; and
wherein the helmet creates a digital scan of the user's head and facial hair using its internal sensors, replicates the previous haircut, saves it, and repeats the same haircut, hair length, hairstyle, and hair shape with the same precision, and improving the haircut until the user is satisfied.

13. The helmet of claim 4, wherein the wireless communication is through a network.

14. A method for using a head and facial hair cutting helmet, comprising:
placing the helmet on the desired hair area to be cut or shaved;
activating an application on a mobile device;
capturing a three-dimensional (3D) representation of the hair area;
communicating the 3D representation to the mobile device;
gathering hair through suction openings towards blades;
determining the hair type using sensors adjacent to the blades;
transmitting the hair type to the application;
analyzing data received from the helmet by the application on the mobile device; and
suggesting a suitable haircut; or manually selected by the user;
previewing the haircut on the mobile device in the form of a 3D rendering and providing suggestions on the haircut and visualization of the user appearance after the suggested haircut;
sending commands to automatically move the required blades to execute the cutting or shaving process.

15. The method of claim 14, wherein capturing a 3D representation of the hair area includes gathering data using imaging sensors in the helmet.

16. The method of claim 14, wherein capturing a 3D representation of the hair area includes;
the user taking a photo of themselves with the mobile device and creates a 3D schematic drawing by the application.
